(19) United States
(12) Patent Application Publication
(10) Pub. No.: US 2022/0074294 A1
(43) Pub. Date: Mar. 10, 2022

(54) METHODS OF FORMING NEAR WELLBORE BARRIERS AND REDUCING BACKWASHING OF PROPPANTS

(71) Applicant: Schlumberger Technology Corporation, Sugar Land, TX (US)

(72) Inventors: Dmitriy USOLTSEV, Richmond, TX (US); Jose Alberto ORTEGA ANDRADE, Houston, TX (US); Jiangshui HUANG, Sugar Land, TX (US); Bernhard LUNGWITZ, Wuerzburg (DE)

(21) Appl. No.: 17/416,957

(22) PCT Filed: Dec. 17, 2019
(86) PCT No.: PCT/US2019/066960

§ 371 Date: Jun. 21, 2021

Related U.S. Application Data
(60) Provisional application No. 62/783,564, filed on Dec. 21, 2018.

(51) Int. Cl. E21B 43/267; C09K 8/80

(52) U.S. Cl. CPC E21B 43/267; C09K 8/80

(57) ABSTRACT

Methods of treating a portion of a wellbore include introducing a first treatment fluid to a far-field area of a subterranean formation, the first treatment fluid comprising a first proppant, and introducing a second treatment fluid to a near wellbore area of the subterranean formation, the second treatment fluid comprising a second proppant different from the first proppant. The method includes reducing flowback of the first proppant into the wellbore while permitting liquid passage into the wellbore by forming a near wellbore barrier containing the second proppant.

The present application claims priority to U.S. Provisional Application Ser. No. 62/783,564, filed Dec. 21, 2018, which is incorporated herein by reference in its entirety.

### BACKGROUND

The statements in this section merely provide background information related to the present disclosure and may not constitute prior art.

The present disclosure relates generally to the field of the stimulation of wells to facilitate production, and more specifically, to proppants used in such stimulation.

Hydrocarbons (such as oil, condensate, and gas) may be produced from wells that are drilled into subterranean formations containing them. For a variety of reasons, such as low permeability of the reservoirs or damage to the formation caused by drilling and completion of the well, or other reasons resulting in low conductivity of the hydrocarbons to the well, the flow of hydrocarbons into the well may be undesirably low. In this case, the well is “stimulated,” for example, using hydraulic fracturing, chemical (such as an acid) stimulation, or a combination of the two (often referred to as acid fracturing or fracture acidizing).

Hydraulic and acid fracturing treatments may include two stages. A first stage comprises pumping a viscous fluid, called a pad that is typically free of proppants, into the formation at a rate and pressure high enough to break down the formation to create fracture therein. In a subsequent second stage, a proppant-laden slurry is pumped into the formation in order to transport proppant into the fracture(s) created in the first stage. In “acid” fracturing, the second stage fluid may contain an acid or other chemical, such as a chelating agent, that can assist in dissolving part of the rock, causing irregular etching of the fracture face and removal of some of the mineral matter, which results in the fracture not completely closing when the pumping is stopped. Occasionally, hydraulic fracturing may be done without a highly viscosified fluid (such as water) to minimize the damage caused by polymers or the cost of other viscosifiers. After finishing pumping, the fracture closes onto the proppant, which keeps the fracture open for the formation fluid (e.g., hydrocarbons) to flow to the wellbore.

Proppant is typically made of materials such as sand, glass beads, ceramic beads, or other materials. Sand is used frequently as the proppant for fracture treatments. However, for fractures with high closure stress, such as greater than 6,000 pound per square inch (psi) (41.3 MPa), in deep wells or wells with high formation-stresses, higher strength proppant is desired. The closure stress that sand can sustain is normally about 6,000 psi (41.3 MPa), so a closure stress over 6,000 psi (41.3 MPa) could crush the sand into fine particles and collapse the sand pack, which results in insufficient conductivity for the formation fluid to flow to the wellbore. Furthermore, the fine particles may continually flow back during production of the well, and thus the conductivity of the well would reduce further, which results in a short useful life of the well or results in costly refracturing of the well. In addition, some of the proppant may flow out of the fracture and create a choke or diminish the fracture conductivity.

Ceramic proppant has been used to maintain the conductivity of the wells with a high closure stress. Typically, the higher the alumina (Al₂O₃) content, the higher the hardness and toughness of the ceramic proppant, but also the higher the specific gravity. Unless a high viscosity fracturing fluid is used, a high specific gravity may lead to quick gravitational settling of the proppant, which results in difficulty to transport the proppant into the fracture, especially for locations far from the wellbore. Also, quick settling in the fracture leads to lack of proppant on the top part of a fracture, which reduces the productivity of the well. To transport proppant of high specific gravity with fracturing fluid of a low viscosity, fiber can be added to the fluid as an additive. See, for example, U.S. Pat. No. 8,657,002, the entire contents of which are hereby incorporated by reference herein. To use fiber effectively for transporting proppant, there can be an interaction force between fiber and proppant.

Other proppant shapes have been proposed for hydraulic fracturing applications. See, for example, U.S. Patent/Application Nos. 2011/0180259; U.S. Pat. No. 8,562,900; 2016/0115375; U.S. Pat. Nos. 8,562,900; 4,060,497; 5,500,162; 6,197,073; and 2006/0016598. See also, co-pending U.S. Patent Application Nos. 2017/0145298, and 2017/0198191, the entire contents of each are hereby incorporated by reference herein.

Despite the advancements in proppant technology, a need remains for efficiently stimulating well bores while preventing proppants injected into the formation from contaminating the well bore.

### SUMMARY

The following presents a general summary of several aspects of the disclosure in order to provide a basic understanding of the disclosure. This summary is provided to introduce a selection of concepts that are further described below in the detailed description. This summary is not an extensive overview of the disclosure nor is it intended to identify key or critical elements or to delineate the scope of the claims. This summary is also not intended to identify optimal features of the claimed subject matter, nor is it intended to be used as an aid in limiting the scope of the claimed subject matter. The following summary merely presents some concepts of the disclosure in a general form as a prelude to the more detailed description that follows.

An aspect of the present disclosure is a method of treating a portion of a well bore. The method includes introducing a first treatment fluid to a far wellbore area of a subterranean formation, the first treatment fluid comprising a first proppant; introducing a second treatment fluid to a near wellbore area of the subterranean formation, the second treatment fluid comprising a second proppant, wherein the second proppant is different from the first proppant; and reducing backwash of the first proppant into the well bore while permitting liquid passage into the well bore by forming a near wellbore barrier containing the second proppant.

The near wellbore barrier forms as the second proppant lodges and interconnects in the near wellbore area of the subterranean formation, the near wellbore barrier containing gates between the interconnected second proppant, wherein a gate size is less than an average size of the first proppant. The near wellbore barrier may have a liquid permeability of 0.001 to 1×10⁵ cm². The near wellbore barrier may reduce an amount of backwash of the first proppant by 1 to 100%. The far wellbore area of the subterranean formation may extend an average of 10 to 300 meters from an opening of the well bore. The near wellbore area of the subterranean formation may extend an average of 0 to 10 meters from an opening of the well bore. The first proppant may have an average size of 0.1 mm to 5 mm. The first proppant may have a spherical shape with a roundness and sphericity of more than 0.7, and an average diameter of 0.2 mm to 5 mm. A concentration of the first proppant may be from about 0.01 to about 80% by weight of the first treatment fluid.

The second proppant has an average length of 2 mm to 10 mm, an average width of 0.2 mm to 1.5 mm, and an average length to width of 2:1 to 10:1. The second proppant may have a cross section in a shape selected from the group consisting of a triangle, a bi-rod shape, a trefoil shape, a quatrefoil shape, a star shape, and a pentagram shape. The second treatment fluid may contain a second proppant and third proppant, wherein the second proppant is at least 100 grams and up to 30 percent by weight of a total amount of proppants in the second treatment fluid. The second treatment fluid may contain a concentration of 100 to 2,400 grams per liter of the second proppant. The first treatment fluid may be introduced as part of a first group of treatment fluid, the first group of treatment fluid containing from 1-4 proppants in different fluids.

Another aspect of the present disclosure is a near wellbore barrier formed according to any of the methods in the previous paragraph is disclosed.

Yet another aspect of the present disclosure is a method of forming near wellbore barriers, the method including introducing a first proppant to a far subterranean formation; introducing a second proppant to a near-subterranean formation; and forming a near-subterranean formation barrier as the second proppant lodges and interconnects in the near-subterranean formation area, the near-subterranean formation barrier containing gates between the interconnected second proppant, wherein a gate size is less than an average size of the first proppant, and the near-subterranean formation barrier permits liquid passage and reduces backwashing of the first proppant.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

### BRIEF DESCRIPTION OF THE DRAWINGS

For simplicity and clarity of illustration, the drawing and/or figures illustrate the general manner of the method disclosed herein and components thereof. Descriptions and details of well-known features and techniques may be omitted to avoid unnecessarily obscuring the disclosure.

For detailed understanding of the present disclosure, references should be made to the following detailed description of the several aspects, taken in conjunction with the accompanying drawings, in which like elements have been given like numerals and wherein:

FIG. 1 shows an illustration of the distribution of the proppant-laden fracturing treatment (Suspension) and the overflush fluid (Water) at the end of the overflush process.

FIG. 2 represents a schematic view of a portion of a well bore, wherein a near wellbore barrier has been formed in the near-bore area of a subterranean formation between the well bore and a far wellbore area.

FIG. 3 represents a schematic view of a near wellbore barrier, wherein the near wellbore barrier contains gates, where an average size of the gates is less than the average size of a proppant, such that backwashing of the proppant into the well bore is reduced while the passage of liquids is permitted.

FIG. 4.1 represents a schematic view of various cross sections of a proppant.

FIG. 4.2 represents a schematic view of particles used for laboratory testing of friction forces developed under simulation displacement.

FIG. 5 represents an illustration of proppant curvature.

FIG. 6 presents a flow chart of a method of treating a portion of a well bore.

FIG. 7.1 represents a schematic view of enhanced interactions between a proppant or solid additive and a near-wellbore fracture.

FIG. 7.2 represents a schematic view of measuring the friction force, (f), between particles and a wall of a pipe whiles placement forces (F) are applied to the particles.

FIG. 8 represents a graph of the friction force (F) as a function of the weight (W) of the particles including trefoil 418, rod 416, oblate 414, and sphere 412.

FIG. 9 represents a graph of a particle size distribution analysis for conventional 20/40 mesh ceramic proppant and rod-like solid additive with trefoil cross-section, before and after crush testing at 10,000 psi (68.9 MPa).

FIG. 10 represents a graph of a relationship between solid volume fraction (SVF) and proppant concentration (PPA or pounds per gallon added).

### DETAILED DESCRIPTION

At the outset, it should be noted that in the development of any actual embodiments, numerous implementation-specific decisions can be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

Before the present methods are described, it is to be understood that this disclosure is not limited to the particular method or apparatus described, as such may vary. One of ordinary skill in the art should understand that the terminology used herein is for the purpose of describing possible aspects, embodiments and/or implementations only, and is not intended to limit the scope of the present disclosure which will be limited only by the appended claims.

The description and examples are presented solely for the purpose of illustrating some embodiments and should not be construed as a limitation to the scope and applicability. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to a few specific points, it is to be understood that inventors appreciate and understand that any and all data points within the range are to be considered to have been specified, and that inventors possession of the entire range and all points within the range disclosed and enabled the entire range and all points within the range.

The following definitions are provided in order to aid those skilled in the art in understanding the detailed description.

### Definitions

The term “treatment”, or “treating”, refers to any subterranean operation that uses a fluid in conjunction with a desired function and/or for a desired purpose. The term “treatment”, or “treating”, does not imply any particular action by the fluid.

As used herein, the term “treatment fluid” refers to any pumpable and/or flowable fluid used in a subterranean operation in conjunction with a desired function and/or for a desired purpose. In some examples, the pumpable and/or flowable treatment fluid may have any suitable viscosity, such as a viscosity of from about 1 cP to about 10,000 cP (0.001 to 10 Pa*s), such as from about 10 cP to about 1000 cP (0.01 to 1 Pa*s), or from about 10 cP to about 100 cP (0.01 to 0.1 Pa*s), at the treating temperature, which may range from a surface temperature to a bottom-hole static (reservoir) temperature, such as from about 0° C. to about 200° C., or from about 10° C. to about 120° C., or from about 25° C. to about 100° C., and a shear rate (for the definition of shear rate reference is made to, for example, Introduction to Rheology, Barnes, H.; Hutton, J. F; Walters, K. Elsevier, 1989, the entire contents of which are hereby incorporated by reference here) in a range of from about 1 s⁻¹ to about 1000 s⁻¹, such as a shear rate in a range of from about 100 s⁻¹ to about 1000 s⁻¹, or a shear rate in a range of from about 50 s⁻¹ to about 500 s⁻¹ as measured by common methods, such as those described in textbooks on rheology, including, for example, Rheology: Principles, Measurements and Applications, Macosko, C. W., VCH Publishers, Inc. 1994, the entire contents of which are hereby incorporated by reference here.

The term “fracturing” refers to the process and methods of breaking down a geological formation and creating a fracture, i.e., the rock formation around a well bore, by pumping fluid at very high pressures (pressure above the determined closure pressure of the formation), in order to increase production rates from a hydrocarbon reservoir. The fracturing methods otherwise use conventional techniques known in the art.

The term “particulate” or “particle” refers to a solid 3D object with maximal dimension significantly less than 1 meter. Here “dimension” of the object refers to the distance between two arbitrary parallel planes, each plane touching the surface of the object at least one point. The maximal dimension refers to the biggest distance existing for the object between any two parallel planes and the minimal dimension refers to the smallest distance existing for the object between any two parallel planes.

It should be understood that, as used herein, “first,” “second,” “third,” etc., are arbitrarily assigned designator and are merely intended to differentiate between two or more types of an object, action, etc., as the case may be, and does not indicate any particular orientation or sequence. Furthermore, it is to be understood that the mere use of the term “first” does not require that there be any “second,” and the mere use of the term “second” does not require that there be any “first” or “third,” etc.

It should also be understood that as used herein and in the appended claims, the singular forms “a,” “an,” and “the” may include plural referents unless the context clearly dictates otherwise. Thus, for example, reference to “a treatment fluid” may refer to one or several treatment fluids and reference to “a method of treating” includes reference to equivalent features and methods known to those skilled in the art, and so forth.

This disclosure is not limited in its application to the details of construction and the arrangement of components set forth in the following description or illustrated in the drawings. The disclosure is capable of other embodiments, implementations or aspects and of being practiced or of being carried out in various ways. Also, the use of “including,” “comprising,” “having,” “containing,” “involving,” “consisting” and variations thereof, is meant to encompass the items listed thereafter and equivalents thereof as well as additional items.

As used herein, the term “rod-shaped particle,” “rod-shaped particles,” “retention proppant,” “oblong proppant,” and “elongate proppant” refers to a particle(s) having a geometrically shaped cross-section and dimensions in which a length of the particle(s) is greater than a cross-sectional width of the particle(s). The length to width/diameter ratio may be, for example, at least 2:1. The cross-sectional geometric shape may be substantially circular, and the rod-shaped particle has a length that is greater than the cross-sectional diameter of the particle. The rod-shaped particles are not limited to having a cross-sectional geometric shape of circular, and other cross-sectional shapes may be used, such as triangular or rectangular. Further, the rod-shaped particle may be substantially straight over the length of the particle, or the particle may have a degree of curvature over the length of the particle. Curvature here refers to the rod-shaped particle having some bend, such that a main axis along a mid-line of the rod-shaped particle is not straight.

The term “average size” refers to an average size of solids in a group of solids of each type. In each group j of particles or flakes average size can be calculated as mass-weighted value

$${\overline{L}}_{j} = \frac{{\sum }_{i = 1}^{N} {l}_{i} {m}_{i}}{{\sum }_{i = 1}^{N} {m}_{i}} \qquad Eq ( 1 )$$

where N—number of particles or flakes in the group, (i=1 . . . N)—sizes of individual particles or flakes; mi (i=1 . . . N)—masses of individual particles or flakes.

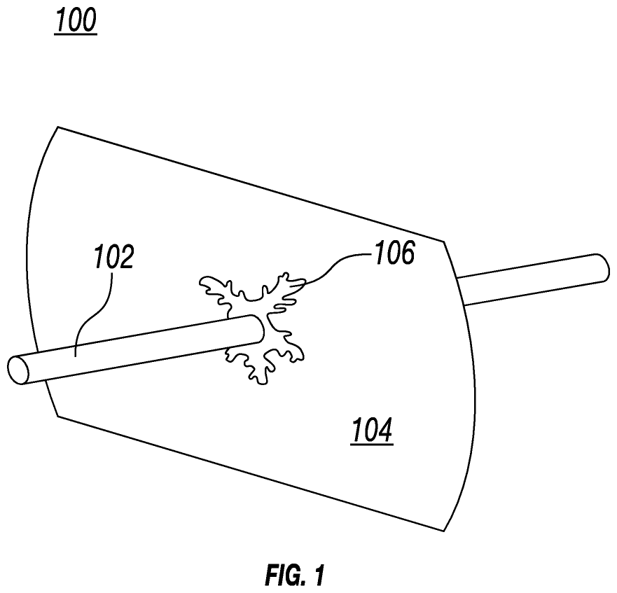

FIGS. 1-3 represent examples of well sites in which a method of treating a portion of a well bore to reduce backwashing of a proppant may be performed. The method introduces compositions made of blends of particles or blends of proppants. The method may include introducing a first treatment fluid or stimulant fluid, wherein the first treatment fluid includes a first proppant or a first blend of more than one type or size of proppant that includes the first proppant. The first treatment fluid may be introduced as part of a first group of treatment fluid. The first group of treatment fluids may contain from 1-4 different proppants in from 1-4 different fluids.

The first proppant may have a size and a shape that is capable of passing into the far wellbore area of a subterranean formation. The method may include introducing the first treatment fluid, which can result in jamming, lodging, or anchoring the first proppant or a first blend of proppants which includes the first proppant, into the voids of the far wellbore area of the subterranean formation. Such voids may be a perforation tunnel, hydraulic fracture, or wormhole. The introduction of the first treatment fluid can be a single action or multiple actions, as desired to stimulate subterranean liquid production.

As schematically depicted in FIG. 1, one problem encountered during a hydraulic fracturing operation 100 is that the hydraulic pressures used in the well bore 102 to fracture a subterranean formation and embed proppant in the far wellbore area of the subterranean formation can be so high that the pressure pushes the proppant-laden fracturing treatment proppant 104, or blend of proppants from the near wellbore areas into the far wellbore areas, leaving areas filled with the overflush fluid (water) 106. This phenomenon is sometimes called “overflushing.” This lack of proppant in the near wellbore area can result in the fractures or voids of the near wellbore area closing after the stimulating pressure is reduced before or during production. As fractures or voids in the near wellbore area close, the production of subterranean liquids can be reduced due to choking or constriction of near wellbore voids. This near wellbore choking can reduce the permeability of the near wellbore passage of subterranean liquids from the stimulated far wellbore area, even when the far wellbore area remains stimulated with proppants still in place.

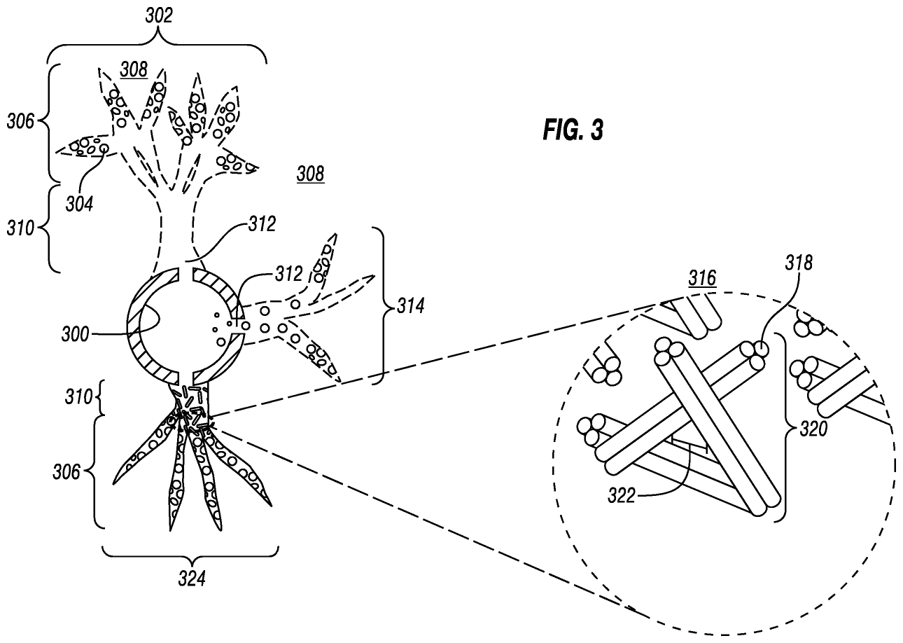

In addition, as depicted in the right part of FIG. 3, another challenge has been that once the pressure of hydraulic fracturing are reduced, the proppant may dislodge from the far wellbore area, backwashing or re-entering the well bore. “Backwashing” refers to the flowback of proppant into the well bore. This backwashing can reduce the production of subterranean liquids from the far wellbore areas as once propped voids close due to the loss of proppant. This backwashing can also return proppants into the well bore during production, which can damage or wear on expensive equipment.

It has been discovered that the introduction of a larger proppant can reduce or lessen this near wellbore choking by jamming or anchoring in the near wellbore area. However, it has also been discovered that if a larger proppant is introduced before a smaller proppant, then the larger proppant might block the smaller proppant from reaching the far wellbore area, which can result in unsuccessful stimulation of the far wellbore area. Also, if the larger proppant occupies too much void space, then the production or passage of the subterranean liquid can be reduced to impractical levels by a loss of permeability.

As schematically depicted in the bottom part 324 of FIG. 3, it has been discovered that a second proppant or retention proppant can be designed to change the shape of the proppant while increasing the length and aspect ratio of the proppant, such that the proppant is capable and/or more likely to lodge in the voids or fractures of the near wellbore area of the subterranean formation. It has also been found that the size and shape of the proppant can be reduced in directions, such as width or cross section to reduce the internal volume of the proppant while maintaining the strength of the proppant. This increased length and reduced internal volume can allow for these retention proppants to lodge in and prop larger voids of the near wellbore area to provide sufficient permeability while reducing or eliminating the problem of near wellbore washout.

In more detail, FIG. 3 shows a schematic depiction of various stages along a length of a well bore 300, where stages of the well bore are being hydraulically fractured and propped. In a previous stage 302, the stimulant proppant 304 can be introduced through a perforation 312 and through the near wellbore area 310 to the far wellbore area 306 of the subterranean formation 308, leaving the near wellbore area 310 without proppant due to overflushing. Once pressure is reduced as depicted in stage 314, then the stimulant proppant 304 would backwash or flowback into the perforation 312 and the well bore 300. However, in an example of the well-bore fracking stage 324 (with expanded view 316), a retention proppant 318 can be introduced to the far wellbore area 306. Then a retention proppant 318 can be introduced to the near wellbore area 310. As depicted in expanded view 316, the retention proppant 318 forms a near wellbore net 320 having a gate 322, wherein the size of the gate is smaller than a size of the stimulation proppant 304, which reduces or eliminates backwashing or flowback of the stimulation proppant into the well bore.

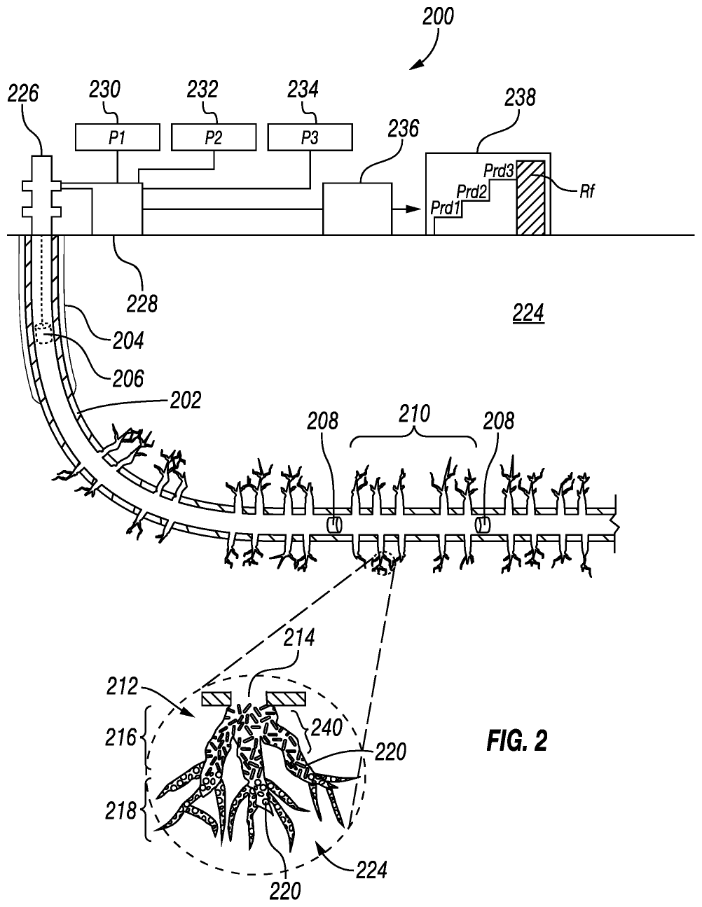

Referring to FIG. 2, in a broader view of the method, the method can be part a hydraulic fracturing operation 200. In an embodiment, the well bore 202 has a near wellbore region that is encased in a cement sheath 204. Before hydraulic fracturing a stage, a perforation tool 206 may be inserted into the well bore to introduce perforations 214 into the sides of well bore, connecting the well bore 202 to the subterranean formation 224. A stage 212 undergoing hydraulic fracturing 210 can be isolated from the rest of the well bore by stage separators 208. An operation module 226 may be connected to a pump 228, and the pump is connected to a first container 230 containing a first proppant (P1), a second container 232 containing a second proppant (P2), and a third container 234 containing a third proppant (P3).

The pump can also be connected to a controller 236. The controller may provide a real-time display of the hydraulic fracturing process 238. As shown by this display 238, a retention fluid (Rf) may be introduced and productions Prd1, Prd2, and Prd3 may be injected in series.

In an example, the first and third proppants may be stimulant proppants. The second proppant may be a retention proppant. Within the fracturing stage 210, the first proppant or stimulation proppant 222 may be introduced through the perforation 214 into the far wellbore area 218 of the subterranean formation 224. Then, a second proppant or retention proppant 220 is introduced to the near wellbore area 216 to form a near wellbore net 240.

Moreover, it has been found that certain sizes and shapes of second proppant or retention proppant can be created that tend to arrange themselves into near wellbore barriers in the form of a net or web of retention proppant that can resemble a 3D log jam. The near wellbore barrier formed has also been found to have gates as illustrated in the enlarged view 316 of FIG. 3, wherein the gates have a size, longest opening, or span that can be smaller than the average size of a first or stimulant proppant. The near wellbore barrier can reduce or eliminate the backwashing of the stimulant proppant, because the gate openings are smaller than the size of the stimulant proppant while still allowing for the passage or flow of subterranean liquids through the near wellbore barrier.

The near wellbore area of the subterranean formation is the volume, portion, or zone of the subterranean formation that extends outward from 0 to 10 meters from the surface of the well bore, including from 0.1 to 3 meters outward. The far wellbore area may be the volume or portion of the subterranean formation that extends outward from 3 to 300 meters from the surface of the well bore, or from 10 to 300 meters outward, or from 10 to 200 meters from the surface of the well bore.

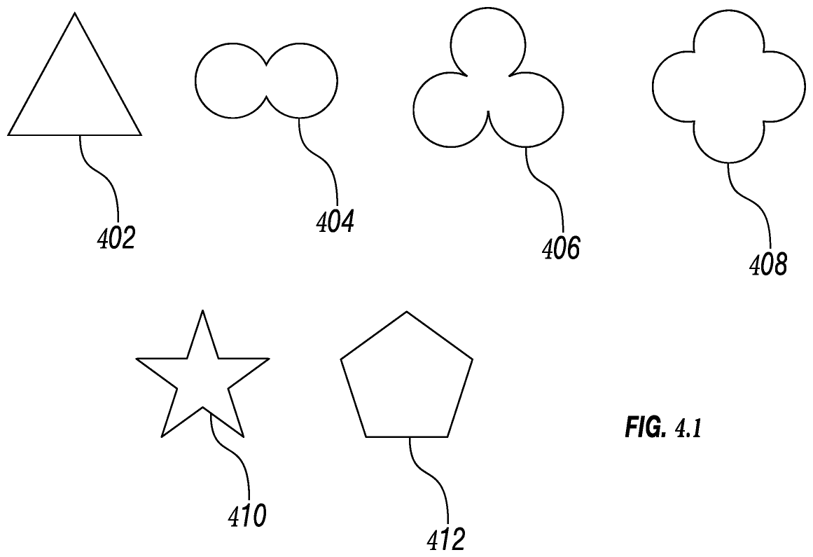

FIGS. 4.1, 4.2, and 5 depict example geometries of the proppant. As shown in FIG. 4.1, the proppant may have various cross-sectional shapes, including a triangle 402, a bi-rod shape 404, a trefoil shape 406, a quatrefoil shape 408, a star shape 410, and a pentagram shape 412. As shown in FIG. 4.2, the proppant may have various geometries, such as sphere 412, an oblate 414, a rod 416, and a trefoil 418 shape.

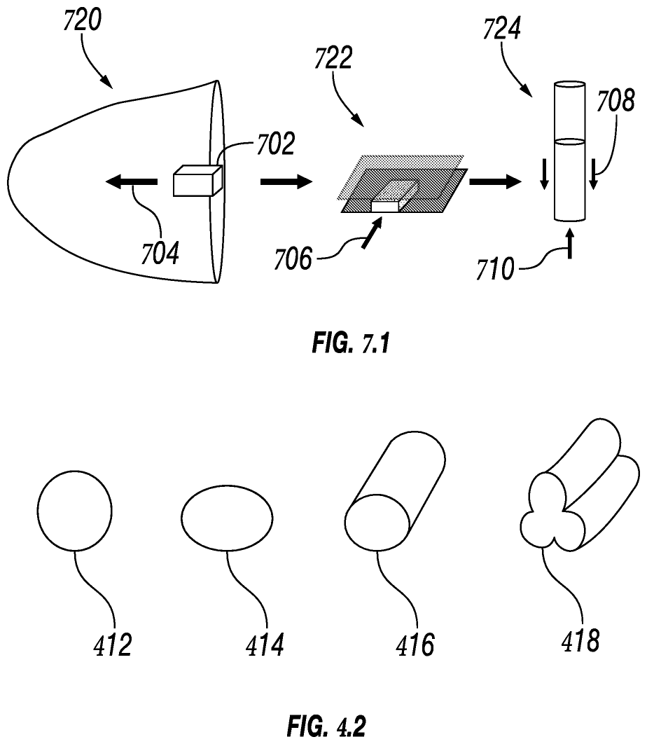

As shown in FIG. 5, the proppant may optionally have a curvature. The curvature may be indicated by α being greater than D (α>D), wherein D is the width of the rod-shaped particle at one end, from a first edge point to a second edge point, and α is a total width at an opposite end of the particle as measured from a common edge with the one end to a furthest edge from the common edge at the opposite end.

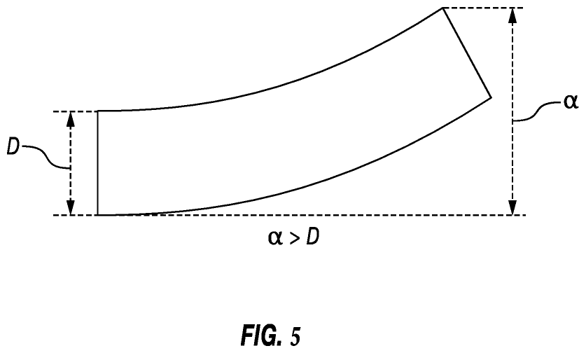

FIG. 6 shows an example method 600 which may be used at the wellsites 100, 200 to prevent backwash of proppant into the wellbore 102, 202. As shown in FIG. 6, in an example of the method, the method 600 typically starts with drilling a well bore into a subterranean formation having a subterranean liquid therein 602. The well bore is perforated 604 before hydraulic fracturing. A stimulant proppant can be introduced through perforations into the far wellbore area 606. The method may include repeating the introduction of stimulant proppant through the perforations and into the far wellbore area 614 to stimulate and prop the subterranean formation as desired. The hydraulic fracturing of a stage may be monitored and directed by a controller.

Once the stage is found to have been sufficiently stimulated, then the controller can direct the pump to introduce a retention fluid or second treatment fluid into a near-well area of the subterranean formation 608. The method can include forming a near wellbore net as oblong proppant lodge and interconnect in the near wellbore area of the subterranean on 610. In an aspect, the method can include reducing an amount of stimulant proppant backwashing from the far wellbore area 612. The method can include 616 repeating the process, including procedures 606-612 for additional stages. The second proppant is a “tail-in” proppant and the introduction of the second treatment fluid, containing the second proppant, is the last introduction of a treatment fluid containing a proppant to the well bore before production of the subterranean liquid and/or completion of the stage and/or well-bore. The second proppant may be a tail-in proppant and is added during the final proppant stage of a multi-fracture treatment.

The method 606 introducing a first treatment fluid to a far wellbore area of a subterranean formation involves introducing the first treatment fluid including a first proppant, sometimes referred to as a stimulant proppant. The first treatment fluid can contain a first proppant or a blend of proppants that includes the first proppant. The first treatment fluid can also include a carrier fluid, a viscosifying agent, and/or a fiber. The first proppant may have a spherical shape with a roundness and sphericity of more than 0.7, including from 0.7 to 1.0, including from 0.8 to 0.95, as per current industrial standard; and an average diameter of 0.2 mm to 5 mm, including from 0.3 mm to 4 mm, including from 1 mm to 3 mm. The first proppant may have an average diameter of 0.2 mm to 5 mm, including from 0.3 mm to 4 mm, including from 1 mm to 3 mm. A first proppant or stimulant proppant can lodge and stimulate production of the far wellbore area of a subterranean formation.

The first proppant or first blend of proppants can be contained in the first treatment fluid at a concentration of from about 0.01 to about 80% by weight of the first treatment fluid, including a concentration in the range of from about 0.1 to about 25% by weight of the treatment fluid, or a concentration in the range of from about 1 to about 10% by weight of the treatment fluid.

The method 608 introducing a second treatment fluid to a near wellbore area of a subterranean formation includes introducing the second treatment fluid including a second proppant. The second treatment fluid can contain a second proppant or a second blend of proppants that includes the second proppant. The first and second treatment fluids may be different, but may share one or more components. In an example, the first proppant and second proppant may be different, but may share one or more properties, materials, or measurements, so long as they differ in a least one shape or dimension. The second treatment fluid can also include a carrier fluid, a viscosifying agent, and/or a fiber. The second proppant has an oblong or cylindrical shape. The second proppant may have a length size of 2 mm to 10 mm, including from 2 mm to 8 mm, including from 3 to 7 mm. The second proppant has an average width of 0.2 mm to 1.5 mm, including from 0.3 mm to 1.2 mm, including from 0.5 to 1 mm. The second proppant may have an average length to width of 2:1 to 10:1, including from 2.5:8, including from 3:7. The second proppant may have a cross section in a shape selected from the group consisting of a triangle 402, a bi-rod shape 404, a trefoil shape 406, a quatrefoil shape 408, a star shape 410, and a pentagram shape 412 as shown in FIG. 4.1.

The second treatment fluid contains a concentration of 100 to 2,400 grams per liter of the second proppant, including 150 to 2,200 grams per liter, including from 200 to 2,000 grams per liter of the second proppant. The second treatment fluid may contain a second blend of proppants, including at least a second proppant and a third proppant. The second treatment fluid can contain a fourth, fifth, sixth, etc. proppant. The third proppant can be the same or different from the first proppant or the second proppant. The second treatment fluid may contain a second proppant and a third proppant, wherein the second proppant is at least 100 grams and up to 30 percent by weight of a total amount of proppants in the second treatment fluid, including at least 120 grams and up to 25 percent by weight, and including from 3 to 20 percent by weight of a total amount of proppants in the second treatment fluid. The second treatment fluid may contain a second proppant and a third proppant, wherein the second proppant is 0.1 to 30 percent by weight of a total amount of proppants in the second treatment fluid, including 1 to 25 percent by weight, and including 3 to 20 percent by weight of a total amount of proppants in the second treatment fluid.

The method 612 of reducing the backwash includes reducing backwash of the first proppant or the first blend of proppants from the far wellbore back into the well bore by forming a near wellbore barrier. The near wellbore barrier may be a self-assembling net or webbing that resembles a 3D logjam of the second proppant when the second proppant interconnects with itself and connects with the sides of the near wellbore void spaces. The near wellbore barrier may contain gates or openings in the near wellbore barrier, wherein the average gate size or longest span across the gate opening is smaller than the average size of the first proppant or at least one of the proppants making up the first blend of proppants. The structure of the near wellbore barrier can help to support and reinforce the void spaces of the near wellbore area of the subterranean formation. In an embodiment, the gates formed in the near wellbore barrier allow for the passage of subterranean liquids while selectively excluding or reducing the passage of the first proppant or at least one of the proppants from the first blend of proppants.

The near wellbore barrier has a liquid permeability of from 0.001 to 1×10⁵ cm², including 1×10⁻³ to 1×10⁻⁴ cm². The method may include reducing an amount or percentage of the first proppant that backwashes or returns to the well bore, which is measured relative to a base line measured before without forming the near wellbore barrier. The reduction of the percentage of first proppant or first blend of proppants may be from about 1 to about 100%, including about 2 to about 80%, including about 5 to about 50%.

The method may also include 610 forming a near wellbore net in a subterranean formation, wherein the well bore comprises a casing and at least one hole on the casing, the hole having a diameter, the method further including: providing a pad fluid comprising a stimulant proppant, the stimulant proppant having a stimulant size and a stimulant shape; introducing the pad fluid through the hole to a far wellbore area of the subterranean formation; providing a retention fluid comprising an oblong proppant, the oblong proppant having an oblong size and an oblong shape; introducing the retention fluid to the near wellbore area of the subterranean formation; forming a near wellbore net as the oblong proppant lodge and interconnect in the near wellbore area of the subterranean formation, the near-wellbore net containing gates between the interconnected oblong proppant, wherein a gate size is less than the stimulant size of the stimulant proppant and permits hydrocarbon passage; and reducing an amount of stimulant proppant that backwashes into the hole during subterranean liquid production. The method may be performed in various orders and repeated as desired.

In more detail, the treatment fluid, including the first and second treatment fluids, are particles or blends of particles in a carrier fluid. The carrier fluid may be water: fresh water, produced water, seawater. Other non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil. Additionally, the carrier fluid may be a brine, and/or may include a brine. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain applications, the carrier fluid may include a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate.

Proppant selection involves many compromises imposed by economical and practical considerations. Such proppants can be natural or synthetic (including but not limited to glass beads, ceramic beads, sand, polymeric and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. Irregular shaped particles may be used. International application WO 2009/088317 discloses a method of fracturing with a slurry of proppant containing from 1 to 100 percent of stiff, low elasticity, low deformability elongated particles. US patent application 2007/768393 discloses proppant that is in the form of generally rigid, elastic plate-like particles having a maximum to minimum dimension ratio of more than about 5, the proppant being at least one of formed from a corrosion resistant material or having a corrosion resistant material formed thereon. Each of the above is herein incorporated by reference such that the entire contents of which are hereby incorporated by reference here.

The proppant or particle(s) may also have a specific shape (referred to herein as specific-shaped particulates) to enhance the bridging capability and stability of the near wellbore barrier. The specific-shaped particulates may have a rod, cylinder, or tube shape with a cross section such as, for example, a triangle, bi-rod shape, trefoil, and quatrefoil. See FIG. 4.1. It is believed that incorporating a specific-shaped particulate, such a particulate having a trefoil shaped cross section, may (1) enhance the bridging capability of the composition due to enhanced friction forces between the particulate and the confining geometry of the perforation holes and voids behind the casing, (2) enhance the barrier stability due to the enhanced friction forces and the better interaction of the particulate with the fibers and (3) act as proppant in the voids behind the casing prone to closure.

The particle(s) can be embodied as degradable material. Non-limiting examples of degradable materials that may be used include certain polymer materials that are capable of generating acids upon degradation. These polymer materials may herein be referred to as “polymeric acid precursors.” These materials are typically solids at room temperature. The polymeric acid precursor materials include the polymers and oligomers that hydrolyze or degrade in certain chemical environments under known and controllable conditions of temperature, time and pH to release organic acid molecules that may be referred to as “monomeric organic acids.” As used herein, the expression “monomeric organic acid” or “monomeric acid” may also include dimeric acid or acid with a small number of linked monomer units that function similarly to monomer acids composed of one monomer unit.

Polymer materials may include those polyesters obtained by polymerization of hydroxycarboxylic acids, such as the aliphatic polyester of lactic acid, referred to as polylactic acid; glycolic acid, referred to as polyglycolic acid; 3-hydroxbutyric acid, referred to as polyhydroxybutyrate; 2-hydroxyvaleric acid, referred to as polyhydroxyvalerate; epsilon caprolactone, referred to as polyepsilon caprolactone or polyprolactone; the polyesters obtained by esterification of hydroxyl aminoacids such as serine, threonine and tyrosine; and the copolymers obtained by mixtures of the monomers listed above. A general structure for the above-described homopolyesters is:

H—{O—[C(R₁,R₂)]ₓ—[C(R₃,R₄)]_{y}—C═O}_{z}—OH Eq (2)

where, R₁, R₂, R₃, R₄ is either H, linear alkyl, such as CH₃, CH₂CH₃ (CH₂)ₙCH₃, branched alkyl, aryl, alkylaryl, a functional alkyl group (bearing carboxylic acid groups, amino groups, hydroxyl groups, thiol groups, or others) or a functional aryl group (bearing carboxylic acid groups, amino groups, hydroxyl groups, thiol groups, or others); x is an integer between 1 and 11; y is an integer between 0 and 10; and z is an integer between 2 and 50,000.

In the appropriate conditions (pH, temperature, water content) polyesters like those described herein can hydrolyze and degrade to yield hydroxycarboxylic acid and compounds that pertain to those acids referred to in the foregoing as “monomeric acids.”

One example of a suitable polymeric acid precursor, as mentioned above, is the polymer of lactic acid, sometimes called polylactic acid, “PLA,” polylactate or polylactide. Lactic acid is a chiral molecule and has two optical isomers. These are D-lactic acid and L-lactic acid. The poly(L-lactic acid) and poly(D-lactic acid) forms are generally crystalline in nature. Polymerization of a mixture of the L- and D-lactic acids to poly(DL-lactic acid) results in a polymer that is more amorphous in nature. The polymers described herein are generally linear. The degree of polymerization of the linear polylactic acid can vary from a few units (2-10 units) (oligomers) to several thousands (e.g. 2000-5000). Cyclic structures may also be used. The degree of polymerization of these cyclic structures may be smaller than that of the linear polymers. These cyclic structures may include cyclic dimers.

Another example is the polymer of glycolic acid (hydroxyacetic acid), also known as polyglycolic acid (“PGA”), or polyglycolide. Other materials suitable as polymeric acid precursors are all those polymers of glycolic acid with itself or other hydroxy-acid-containing moieties, as described in U.S. Pat. Nos. 4,848,467; 4,957,165; and 4,986,355, the entire contents of which are hereby incorporated by reference here.

The polylactic acid and polyglycolic acid may each be used as homopolymers, which may contain less than about 0.1% by weight of other comonomers. As used with reference to polylactic acid, “homopolymer(s)” is meant to include polymers of D-lactic acid, L-lactic acid and/or mixtures or copolymers of pure D-lactic acid and pure L-lactic acid. Additionally, random copolymers of lactic acid and glycolic acid and block copolymers of polylactic acid and polyglycolic acid may be used. Combinations of the described homopolymers and/or the above-described copolymers may also be used.

Other examples of polyesters of hydroxycarboxylic acids that may be used as polymeric acid precursors are the polymers of hydroxyvaleric acid (polyhydroxyvalerate), hydroxybutyric acid (polyhydroxybutyrate) and their copolymers with other hydroxycarboxylic acids. Polyesters resulting from the ring opening polymerization of lactones such as epsilon caprolactone (polyepsiloncaprolactone) or copolymers of hydroxyacids and lactones may also be used as polymeric acid precursors.

Polyesters obtained by esterification of other hydroxyl-containing acid-containing monomers such as hydroxyaminoacids may be used as polymeric acid precursors. Naturally occurring aminoacids are L-aminoacids. Among the 20 most common aminoacids the three that contain hydroxyl groups are L-serine, L-threonine, and L-tyrosine. These aminoacids may be polymerized to yield polyesters at the appropriate temperature and using appropriate catalysts by reaction of their alcohol and their carboxylic acid group. D-aminoacids are less common in nature, but their polymers and copolymers may also be used as polymeric acid precursors.

NatureWorks, LLC, Minnetonka, Minn., USA, produces solid cyclic lactic acid dimer called “lactide” and from it produces lactic acid polymers, or polylactates, with varying molecular weights and degrees of crystallinity, under the generic trade name NATUREWORKS™ PLA. The PLA's currently available from NatureWorks, LLC have number averaged molecular weights (Mn) of up to about 100,000 and weight averaged molecular weights (Mw) of up to about 200,000, although any polylactide (made by any process by any manufacturer) may be used. Those available from NatureWorks, LLC typically have crystalline melt temperatures of from about 120 to about 170° C., but others are obtainable. Poly(d,l-lactide) at various molecular weights is also commercially available from Bio-Invigor, Beijing and Taiwan. Bio-Invigor also supplies polyglycolic acid (also known as polyglycolide) and various copolymers of lactic acid and glycolic acid, often called “polyglactin” or poly(lactide-co-glycolide).

The extent of the crystallinity can be controlled by the manufacturing method for homopolymers and by the manufacturing method and the ratio and distribution of lactide and glycolide for the copolymers. Additionally, the chirality of the lactic acid may also affect the crystallinity of the polymer. Polyglycolide can be made in a porous form. Some of the polymers dissolve slowly in water before they hydrolyze.

Amorphous polymers may be useful in certain applications. An example of a commercially available amorphous polymer is that available as NATUREWORKS™ 4060D PLA, available from NatureWorks, LLC, which is a poly(DL-lactic acid) and contains approximately 12% by weight of D-lactic acid and has a number average molecular weight (Mn) of approximately 98,000 g/mol and a weight average molecular weight (Mw) of approximately 186,000 g/mol.

Other polymer materials that may be useful are the polyesters obtained by polymerization of polycarboxylic acid derivatives, such as dicarboxylic acids derivatives with polyhydroxy containing compounds, in particular dihydroxy containing compounds. Polycarboxylic acid derivatives that may be used are those dicarboxylic acids such as oxalic acid, propanedioic acid, malonic acid, fumaric acid, maleic acid, succinic acid, glutaric acid, pentanedioic acid, adipic acid, phthalic acid, isophthalic acid, terphthalic acid, aspartic acid, or glutamic acid; polycarboxylic acid derivatives such as citric acid, poly and oligo acrylic acid and methacrylic acid copolymers; dicarboxylic acid anhydrides, such as, maleic anhydride, succinic anhydride, pentanedioic acid anhydride, adipic anhydride, phthalic anhydride; dicarboxylic acid halides, primarily dicarboxylic acid chlorides, such as propanedioic acil chloride, malonyl chloride, fumaroil chloride, maleyl chloride, succinyl chloride, glutaroyl chloride, adipoil chloride, phthaloil chloride. Useful polyhydroxy containing compounds are those dihydroxy compounds such as ethylene glycol, propylene glycol, 1,4 butanediol, 1,5 pentanediol, 1,6 hexanediol, hydroquinone, resorcinol, bisphenols such as bisphenol acetone (bisphenol A) or bisphenol formaldehyde (bisphenol F); polyols such as glycerol. When both a dicarboxylic acid derivative and a dihydroxy compound are used, a linear polyester results. It is understood that when one type of dicaboxylic acid is used, and one type of dihydroxy compound is used, a linear homopolyester is obtained. When multiple types of polycarboxylic acids and/or polyhydroxy containing monomer are used copolyesters are obtained. According to the Flory Stockmayer kinetics, the “functionality” of the polycarboxylic acid monomers (number of acid groups per monomer molecule) and the “functionality” of the polyhydroxy containing monomers (number of hydroxyl groups per monomer molecule) and their respective concentrations, will determine the configuration of the polymer (linear, branched, star, slightly crosslinked or fully crosslinked). These configurations can be hydrolyzed or “degraded” to carboxylic acid monomers, and therefore can be considered as polymeric acid precursors. As a particular case example, not willing to be comprehensive of all the possible polyester structures one can consider, but just to provide an indication of the general structure of the most simple case one can encounter, the general structure for the linear homopolyesters is:

H—{O—R₁—O—C═O—R₂—C═O}_{z}—OH Eq (3)

where, R₁ and R₂, are linear alkyl, branched alkyl, aryl, alkylaryl groups; and z is an integer between 2 and 50,000. Other examples of suitable polymeric acid precursors are the polyesters derived from phtalic acid derivatives such as polyethylenetherephthalate (PET), polybutylentetherephthalate (PBT), polyethylenenaphthalate (PEN), and the like.

In the appropriate conditions (pH, temperature, water content) polyesters like those described herein can “hydrolyze” and “degrade” to yield polycarboxylic acids and polyhydroxy compounds, irrespective of the original polyester being synthesized from either one of the polycarboxylic acid derivatives listed above. The polycarboxylic acid compounds the polymer degradation process will yield are also considered monomeric acids.

Other examples of polymer materials that may be used are those obtained by the polymerization of sulfonic acid derivatives with polyhydroxy compounds, such as polysulphones or phosphoric acid derivatives with polyhydroxy compounds, such as polyphosphates.

Such solid polymeric acid precursor material may be capable of undergoing an irreversible breakdown into fundamental acid products downhole. As referred to herein, the term “irreversible” will be understood to mean that the solid polymeric acid precursor material, once broken downhole, should not reconstitute while downhole, e.g., the material should break down in situ but should not reconstitute in situ. The term “break down” refers to both the two relatively extreme cases of hydrolytic degradation that the solid polymeric acid precursor material may undergo, e.g., bulk erosion and surface erosion, and any stage of degradation in between these two. This degradation can be a result of, inter alia, a chemical reaction. The rate at which the chemical reaction takes place may depend on, inter alia, the chemicals added, temperature and time. The breakdown of solid polymeric acid precursor materials may or may not depend, at least in part, on its structure. For instance, the presence of hydrolyzable and/or oxidizable linkages in the backbone often yields a material that will break down as described herein. The rates at which such polymers break down are dependent on factors such as, but not limited to, the type of repetitive unit, composition, sequence, length, molecular geometry, molecular weight, morphology (e.g., crystallinity, size of spherulites, and orientation), hydrophilicity, hydrophobicity, surface area, and additives. The manner in which the polymer breaks down also may be affected by the environment to which the polymer is exposed, e.g., temperature, presence of moisture, oxygen, microorganisms, enzymes, pH, and the like.

Some suitable examples of solid polymeric acid precursor material that may be used include, but are not limited to, those described in the publication of Advances in Polymer Science, Vol. 157 entitled “Degradable Aliphatic Polyesters,” edited by A. C. Albertsson, pages 1-138, the entire contents of which are hereby incorporated by reference here. Examples of polyesters that may be used include homopolymers, random, block, graft, and star- and hyper-branched aliphatic polyesters.

Another class of suitable solid polymeric acid precursor material that may be used includes polyamides and polyimides. Such polymers may comprise hydrolyzable groups in the polymer backbone that may hydrolyze under the conditions that exist in cement slurries and in a set cement matrix. Such polymers also may generate byproducts that may become sorbed into a cement matrix. Calcium salts are a nonlimiting example of such byproducts. Nonlimiting examples of suitable polyamides include proteins, polyaminoacids, nylon, and poly(caprolactam). Another class of polymers that may be suitable for use includes those polymers that may contain hydrolyzable groups, not in the polymer backbone, but as pendant groups. Hydrolysis of the pendant groups may generate a water-soluble polymer and other byproducts that may become sorbed into the cement composition. A nonlimiting example of such a polymer includes polyvinylacetate, which upon hydrolysis forms water-soluble polyvinylalcohol and acetate salts.

The particle(s) or the flake(s) can be embodied as material reacting with chemical agents. Some examples of materials that may be removed by reacting with other agents are carbonates including calcium and magnesium carbonates and mixtures thereof (reactive to acids and chelates); acid soluble cement (reactive to acids); polyesters including esters of lactic hydroxylcarbonic acids and copolymers thereof (can be hydrolyzed with acids and bases); active metals such as magnesium, aluminum, zinc and their alloys (reactive to water, acids and bases) etc. Particles and flakes may also be embodied as material that accelerate degradation of other component of the formed barrier. Some non-limited examples of it is using metal oxides (e.g. MgO) or bases (e.g. Mg(OH)₂; Ca(OH)₂) or salts of weak acids (e.g. CaCO₃) for accelerating hydrolysis of polyesters such as polylactic or polyglycolic acids.

The particle(s) or the flake(s) can be embodied as melting material. Examples of meltable materials that can be melted at downhole conditions hydrocarbons with number of carbon atoms >30; polycaprolactones; paraffin and waxes; carboxylic acids such as benzoic acid and its derivatives; etc. Wax particles can be used. The particles are solid at the temperature of the injected fluid, and that fluid cools the formation sufficiently that the particles enter the formation and remain solid. Aqueous wax are commonly used in wood coatings; engineered wood processing; paper and paperboard converting; protective architectural and industrial coatings; paper coatings; rubber and plastics; inks; textiles; ceramics; and others. They are made by such companies as Hercules Incorporated, Wilmington, Del., U.S.A., under the trade name PARACOL®, Michelman, Cincinnati, Ohio, U.S. A., under the trade name MICHEM®, and ChemCor, Chester, N.Y., U.S.A. Particularly suitable waxes include those commonly used in commercial car washes. In addition to paraffin waxes, other waxes, such as polyethylenes and polypropylenes, may also be used.

The particle(s) or the flake(s) can be embodied as water-soluble material or hydrocarbon-soluble material. The list of the materials that can be used for dissolving in water includes water-soluble polymers, water-soluble elastomers, carbonic acids, rock salt, amines, inorganic salts). List of the materials that can be used for dissolving in oil includes oil-soluble polymers, oil-soluble resins, oil-soluble elastomers, polyethylene, carbonic acids, amines, waxes).

The composition may further include a third amount of particulates/flakes having a third average particle size that is smaller than the second average particle/flake size. The composition may also have a fourth or a fifth amount of particles/flakes. Also in some examples, the same chemistry can be used for the third, fourth, or fifth average particle/flake size. Also in some examples, different chemistry can be used for the same third average particle size: e.g. in the third average particle size, half of the amount is PLA and the other half is PGA. For the purposes of enhancing the PVF of the composition, more than three or four particles sizes will not typically be required. However, additional particles may be added for other reasons, such as the chemical composition of the additional particles, the ease of manufacturing certain materials into the same particles versus into separate particles, the commercial availability of particles having certain properties, and other reasons understood in the art.

In certain further examples, the composition further has a viscosifying agent. The viscosifying agent may be any crosslinked polymers. The polymer viscosifier can be a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In other examples, the viscosifying agent is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymer can be made from a polymer comprising pendant ionic moieties, a surfactant comprising oppositely charged moieties, a clay stabilizer, a borate source, and a metal crosslinker. Said examples are described in U.S. Patent Publications US2008-0280790 and US2008-0280788 respectively, the entire contents of each are hereby incorporated by reference here.

The viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. No. 6,435,277 (Qu et al.) and U.S. Pat. No. 6,703,352 (Dahayanake et al.), the entire contents of each are hereby incorporated by reference here. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a certain concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO— Eq (4)

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some examples, a zwitterionic surfactants of the family of betaine is used.

Example cationic viscoelastic surfactants include the amine salts and quaternary amine salts disclosed in U.S. Pat. Nos. 5,979,557, and 6,435,277, the entire contents of which are each hereby incorporated by reference here. Examples of suitable cationic viscoelastic surfactants include cationic surfactants having the structure:

R₁N⁺(R₂)(R₃)(R₄)X— Eq (5)

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X— is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Amphoteric viscoelastic surfactants are also suitable. Example amphoteric viscoelastic surfactant systems include those described in U.S. Pat. No. 6,703,352, for example amine oxides. Other examples of viscoelastic surfactant systems include those described in U.S. Pat. Nos. 6,239,183; 6,506,710; 7,060,661; 7,303,018; and 7,510,009 for example amidoamine oxides, the entire contents of each are hereby incorporated by reference here. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some examples, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X Eq (6)

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

In some examples, the carrier fluid may optionally further comprise fibers. The fibers may be straight, curved, bent or undulated. Other non-limiting shapes may include hollow, generally spherical, rectangular, polygonal, etc. Fibers or elongated particles may be used in bundles. The fibers may have a length of less than about 1 mm to about 30 mm or more. In certain examples the fibers may have a length of 12 mm or less with a diameter or cross dimension of about 200 microns or less, with from about 10 microns to about 200 microns being typical. For elongated materials, the materials may have a ratio between any two of the three dimensions of greater than 5 to 1. In certain examples, the fibers or elongated materials may have a length of greater than 1 mm, with from about 1 mm to about 30 mm, from about 2 mm to about 25 mm, from about 3 mm to about 20 mm, being typical. In certain applications the fibers or elongated materials may have a length of from about 1 mm to about 10 mm (e.g. 6 mm). The fibers or elongated materials may have a diameter or cross dimension of from about 5 to 100 microns and/or a denier of about 0.1 to about 20, more particularly a denier of about 0.15 to about 6.

The fiber may be formed from a degradable material or a non-degradable material. The fiber may be organic or inorganic. Non-degradable materials are those wherein the fiber remains substantially in its solid form within the well fluids. Examples of such materials include glass, ceramics, basalt, carbon and carbon-based compound, metals and metal alloys, etc. Polymers and plastics that are non-degradable may also be used as non-degradable fibers. These may include high density plastic materials that are acid and oil-resistant and exhibit a crystallinity of greater than 10%. Other non-limiting examples of polymeric materials include nylons, acrylics, styrenes, polyesters, polyethylene, oil-resistant thermoset resins and combinations of these.

Degradable fibers may include those materials that can be softened, dissolved, reacted or otherwise made to degrade within the well fluids. Such materials may be soluble in aqueous fluids or in hydrocarbon fluids. Oil-degradable particulate materials may be used that degrade in the produced fluids. Non-limiting examples of degradable materials may include, without limitation, polyvinyl alcohol, polyethylene terephthalate (PET), polyethylene, dissolvable salts, polysaccharides, waxes, benzoic acid, naphthalene based materials, magnesium oxide, sodium bicarbonate, calcium carbonate, sodium chloride, calcium chloride, ammonium sulfate, soluble resins, and the like, and combinations of these. Degradable materials may also include those that are formed from solid-acid precursor materials. These materials may include polylactic acid (PLA), polyglycolic acid (PGA), carboxylic acid, lactide, glycolide, copolymers of PLA or PGA, and the like, and combinations of these. Such materials may also further facilitate the dissolving of the formation in the acid fracturing treatment.

Also, fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like.

The carrier fluid may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some cases, it may be desired to foam the composition using a gas, such as air, nitrogen, or carbon dioxide.

The composition or treatment fluids may be used for carrying out a variety of subterranean treatments, including, but not limited to, drilling operations, fracturing treatments, diverting treatments, zonal isolation and completion operations (e.g., gravel packing). In some examples, the treatment fluids may be used in treating a portion of a subterranean formation. The treatment fluids may be introduced into a well bore that penetrates the subterranean formation as a treatment fluid. For example, the treatment fluid may be allowed to contact the subterranean formation for a period of time. The treatment fluid may be allowed to contact hydrocarbons, formations fluids, and/or subsequently injected treatment fluids. After a chosen time, the treatment fluid may be recovered through the well bore.

To facilitate a better understanding, the following examples are given. In no way should the following examples be read to limit, or define, the scope of the overall invention.

### EXAMPLES

A series of experiments were conducted to demonstrate the methods of treatment.

### Example 1

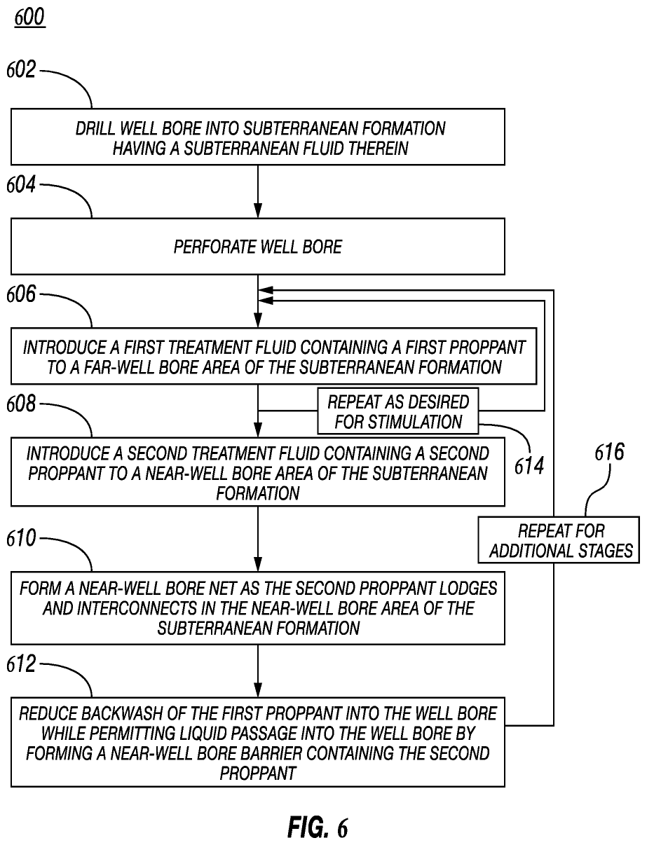

Referring to the schematic in FIG. 7.1, the proppant or “solid additive” is delivered at the end of the fracturing treatment, which can contain any chosen proppant for fracture conductivity. The drag and displacement forces associated with overflushing would result in the pushing of the pack of particles deeper into the fracture. This scenario was simulated in the lab by extracting the relevant physical parameters and boundary conditions. In more detail, a representative element 702 in fracture 720 would be subject to a direction of displacement 704. As schematically depicted in 722, placement force 706 can be exerted on a representative element in a laboratory setting. As shown in scenario 724, one way to provide this data would be to place the representative element in a column to replicate the way the displacement forces 710 would push against the friction forces 708.

The particles considered for laboratory experimentation are shown in FIG. 4.2, include a sphere 412, an oblate 414, a rod 416, and a trefoil 418 shape. These particles were manufactured out of ceramic. A representative element of the solid additive is thought of engaging mechanically with surfaces representing the rock fracture walls. Furthermore, this geometrical abstraction was simulated using a cylindrical boundary (tubular structure), where the outer layer of the solid additive interacts with the experimental surface of the tubular structure. The drag and displacement forces were simulated using a piston, where the solid additive was mechanically displaced through a force acting on the cross-section of the tubular. The experiment recorded the force levels used to move the solid additive pack subjected to displacement-controlled motion.

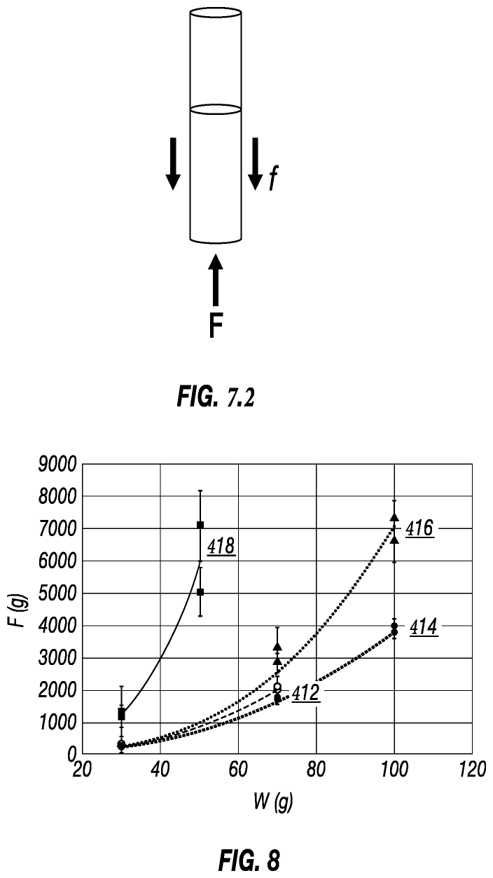

Referring to FIG. 7.2, for the lab experiments, the diameter of the tubular structure was 20 mm, the applied displacement rate was 0.1 mm/s, and the resulting displacements were on the order of a few cm. FIG. 8 shows the experimentally measured friction forces (mean value and standard deviation) as function of amount of material used in the test. The friction force was displayed as the equivalent mass (ratio of measured force and the gravitational constant). The experimental friction force discounted the effect of the self-weight of the sample. The solid additives composed of particles with non-spherical morphologies displayed larger friction forces compared to the spherical morphology (except the oblate case). In particular, rod-like particles with a trefoil cross-section exhibited the superior friction performance of the tested group, followed by rod-like particles with a circular cross-section. Depending on the application, the particle morphology could be designed to develop a desired level of friction resistance, which in turn, can sustain the forces associated with overflushing.

### Example 2

The characteristic size (or representative size of the ensemble's distribution) of the solid additive (proppant) is optimized to improve the near wellbore zone (NWZ) or near wellbore area of the subterranean formation. In conventional practice, the size of proppants chosen for the main fracturing treatment tend to be smaller than, for example, 20/40 mesh (420 μm to 840 μm), for some unconventional treatments. Small proppant sizes can be beneficial due to perceived benefits in proppant transport in order to place as much proppant in the created fracture geometry.

A retention proppant can be designed with a different goal; the formation of a near wellbore barrier that allows for the passage of liquids but prevents the passage of proppants used for stimulation. It has been found that a shape having a greater ability to lodge or anchor in the larger voids of the near wellbore area can reduce or avoid overflushing. For example a spherical proppant, tends to roll along surfaces until finding a void matching its approximate diameter. An oblong proppant tends to lodge or anchor in the void spaces of the larger areas. This might also be accomplished by using a larger proppant, but a desirable performance characteristic will be to deliver much larger permeability compared to conventional proppants. In addition to the anchoring mechanism previously described, a large permeability for the solid additive pack will mitigate the drag and displacement forces developed during overflushing. Large solid additive particles created large pore spaces, which in return increase the permeability of the pack. It is known from the body of knowledge in granular mechanics and packings of particles that the permeability k of a particle pack with characteristic size of d scales such that k∝d\hat{ }n where n˜2 for spherical particles. Consequently, increases in particle size result in non-linear increases in permeability. This ultimately has an effect on the differential pressures developed across the pack of solid additive. Based on Darcy's phenomenological law:

q∝(kpw)/(μL) Eq (7)

the flow rate q across a porous medium scales proportionally with the permeability k and the pressure differential (Δp) per unit length L (μ is the viscosity, w is the width). By enhancing the permeability of the system, the effective pressure differential will be minimized, and the result would be a less disturbed pack of particles. Larger solid additive particles are also desired to assist with the mechanical interactions developed with fracture walls. The size of the solid additive can be tailored to the characteristics of the formation being stimulated, e.g. fracture width (or representative range).

A sample of solid additive with rod structure and trefoil cross-section is characterized using the optical particle size analysis (PSA) technique. The PSA test determines the characteristic size of the particle, depending on the reference model used (e.g. maximum Feret diameter). The particle size analyses are performed on a CAMSIZER® (RETSCH® Technology).

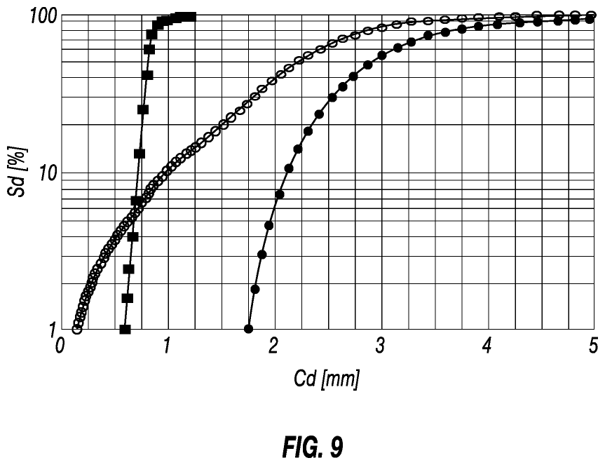

FIG. 9 displays the results from PSA testing of a sample of trefoil particles (trefoil, untested—solid circles) made out of ceramics. The results show the particle size distribution (Sd) versus characteristic size (Cd) for the ensemble, with Dv10 and Dv90 values of 2.2-4.3 mm. The Dv-values correspond to standard percentile values obtained from the statistical analysis of the volume-based distribution. For instance, Dv10 is the particle size at which 10% (by volume) of the sample is smaller and 90% of the sample is larger. For comparison, a conventional sample of 20/40 mesh ceramic particles with mostly spherical morphology is also presented for reference (20/40 mesh spherical, untested—solid squares), with Dv10 and Dv90 values of 0.7-0.9 mm.

Given the different size range between the conventional sample and the sample of trefoil particles, the permeability of the latter system is expected to be larger. However, the sample of trefoil particles is subjected to a standardized ISO 13503-2 crush test, where the maximum load applied was 10,000 psi (68.9 MPa). This crushed sample is tested for PSA, and the result is displayed in the figure (trefoil, tested to 10 k psi (68.9 MPa)—open circles). Even though the new particle size distribution is changed due to particle crushing, the Dv10 value is 1.0 mm, which was larger than the Dv90 of the conventional sample. These results indicate that with the appropriate manufacturing technique and constitutive material properties, large-sized solid additives can impart high permeability to mitigate forces associated with overflushing.

### Example 3

The characteristic size of the near wellbore zone (NWZ) or near wellbore area of the subterranean formation that is to be supported by the solid additive is more specialized compared to conventional designs of tail-ins in hydraulic fracturing. For example, some tail-in designs using conventional ceramic proppants account for up to 30% of the total proppant treatment. In contrast, the retention proppant should be used in such an amount that it will placed in a more targeted near wellbore region. An estimated characteristic size of the NWZ affected by overflushing could be on the order of a few meters. By way of example, assume a radial dimension of 5 m for the affected NWZ. Assuming an initial fracture width of 12 mm, a solid volume fraction of 0.28 (equivalent to 12 PPA), and specific gravity of the solid additive of 3.6, the mass of solid additive delivered would be approximately 2,000 lb (907 kg). This represents a value an order of magnitude smaller than the conventional amount used in tail-in designs which do not address the overflush problem.

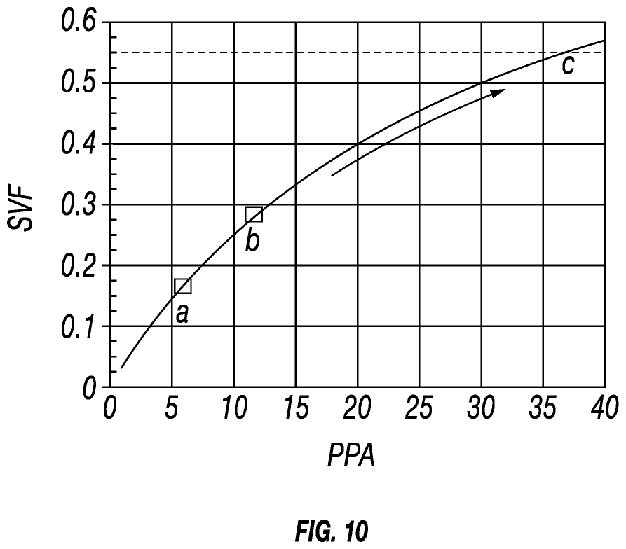

Another design aspect that is particular to the solid additive is the higher concentration of solid delivered downhole. Conventional tail-in designs with small proppants typically remain below e.g. 4-6 PPA (479 to 719 g/L) for practical applications. This concentration limit is such to prevent screen-outs, that is, developing excessive pumping pressures on surface due to the agglomeration of proppant as a result of poor transport or the presence of constrictions. The screen-out effect occurs when enough proppant is agglomerated into a pack. As a result, the solid concentration (or PPA) in the treatment suspension starts to increase, say from point “a” to the “c,” for which the particles in the system becomes an interconnected pack or random loose packing (FIG. 10). At that point, the permeability of the system is at its lowest value and with more accumulation, the pressure used for fluid flow through the pack increases, resulting in the screen-out event.

In contrast, the job design for the solid additive is such that the suspension is design for high concentrations, for e.g. 12 PPA or higher (1,438 g/L). With such concentration, the solid additive may start to concentrate even further once it reaches the NWZ. This event will contribute to the development of the friction forces to anchor the solid additive to the NWZ. Simultaneously, this propensity to further concentrate, say from point “b” to “c” (FIG. 10) has lower probabilities of leading to the occurrence of a screen-out even because 1) the solid additive permeability is much higher than for conventional proppants (choice of large particle size), and 2) the relatively small amount of solid additive material has lower probability to develop large pressures if reaching state C.

The foregoing disclosure and description is illustrative and explanatory, and it can be readily appreciated by those skilled in the art that various changes in the size, shape and materials, as well as in the details of the illustrated construction or combinations of the elements described herein can be made without departing from the spirit of the invention.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

What is claimed is:

1. A method of treating a portion of a well bore, the method comprising:
introducing a first treatment fluid to a far-field area of a subterranean formation, the first treatment fluid comprising a first proppant;
introducing a second treatment fluid to a near wellbore area of the subterranean formation, the second treatment fluid comprising a second proppant different from the first proppant; and
reducing flowback of the first proppant into the wellbore while permitting liquid passage into the wellbore by forming a near wellbore barrier containing the second proppant.

2. The method according to claim 1, wherein the near wellbore barrier forms as the second proppant lodges and interconnects in the near wellbore area of the subterranean formation, the near wellbore barrier containing gates between the interconnected second proppant, wherein a gate size is less than an average size of the first proppant.

3. The method according to claim 1, wherein the near wellbore barrier has a liquid permeability of about 0.001 to 1×10⁻⁵ cm².

4. The method according to claim 1, wherein the near wellbore barrier reduces an amount of backwash of the first proppant by 1 to 100%.

5. The method according to claim 1, wherein the far wellbore area of the subterranean formation extends an average of 10 to 300 meters from an opening of the well bore.

6. The method according to claim 1, wherein the near wellbore area of the subterranean formation extends an average of 0 to 10 meters from an opening of the well bore.

7. The method according to claim 1, wherein the first proppant has an average size of 0.1 mm to 5 mm.

8. The method according to claim 1, wherein the first proppant has a spherical shape with a roundness and sphericity of more than 0.7, and an average diameter of 0.2 mm to 5 mm.

9. The method according to claim 1, wherein a concentration of the first proppant is from about 0.01 to about 80% by weight of the first treatment fluid.

10. The method according to claim 1, wherein the second proppant has an average length of 2 mm to 10 mm, an average width of 0.2 mm to 1.5 mm, and an average length to width ratio of 2:1 to 10:1.

11. The method according to claim 1, wherein the second proppant has a cross section in a shape selected from the group consisting of a triangle, a bi-rod shape, a trefoil shape, a quatrefoil shape, a star shape, and a pentagram shape.

12. The method according to claim 1, wherein the second treatment fluid contains a second proppant and third proppant, wherein the second proppant is at least 100 grams and up to 30 percent by weight of a total amount of proppants in the second treatment fluid.

13. The method according to claim 1, wherein the second treatment fluid contains a concentration of 100 to 2,400 grams per liter of the second proppant.

14. The method of claim 1, wherein the first treatment fluid is introduced as part of a first group of treatment fluid, the first group of treatment fluid containing from 1 to 4 proppants in different fluids.

15. The method of claim 1, wherein the second proppant is a tail-in proppant.

16. A near wellbore barrier formed according to the method of claim 1.

17. A method comprising:
introducing a first proppant to a far subterranean formation region;
introducing a second proppant to a near subterranean formation region; and
forming a near subterranean formation barrier as the second proppant contacts the near-subterranean formation, the near subterranean formation barrier containing gates between the second proppant, wherein a gate size is less than an average size of the first proppant, and the near subterranean formation barrier permits liquid passage and reduces backwashing of the first proppant.

18. The method of claim 17, wherein the far subterranean formation region extends an average of 10 to 300 meters from an opening of the well bore.

19. The method of claim 17, wherein the near subterranean formation region extends an average of 0 to 10 meters from an opening of the well bore.

20. The method of claim 17, wherein the first proppant has an average size of 0.1 mm to 5 mm.
